(19) United States
(12) Patent Application Publication
(10) Pub. No.: US 2007/0219103 A1
(43) Pub. Date: Sep. 20, 2007

(54) Novel rinse solution to remove cross-contamination

(75) Inventors: Tianbao Du, Santa Clara, CA (US); Feng Q. Liu, San Jose, CA (US); Alain Duboust, Sunnyvale, CA (US); Jose Salas-Vernis, San Jose, CA (US); Wei-Yung Hsu, Santa Clara, CA (US)

Correspondence Address: PATTERSON & SHERIDAN, LLP, 3040 POST OAK BOULEVARD, SUITE 1500, HOUSTON, TX, 77056, US

(73) Assignee: APPLIED MATERIALS, INC.

(21) Appl. No.: 11/378,521

(22) Filed: Mar. 17, 2006

(51) Int. Cl. B08B 3/00; C11D 7/32

(52) U.S. Cl. 510/175; 134/34

(57) ABSTRACT

A composition for rinsing a substrate including deionized water, one or more carboxylate acid containing compounds, one or more surfactants, and one or more corrosion inhibitors and a method of using the same is provided. Also a method for rinsing a substrate between exposure to platens including moving the substrate from a first platen to a second platen and exposing the substrate to a rinse solution comprising one or more carboxylate acid containing compounds, one or more surfactants, and one or more corrosion inhibitors.

### BACKGROUND OF THE INVENTION

1. Field of the Invention

Embodiments of the present invention generally relate to a method of preventing cross-contamination of chemical components as a substrate moves through a system with different chemical mechanical polishing and electrochemical mechanical polishing processes.

2. Description of the Related Art

The uniform removal of material from the surface of substrates is critical to successful chemical mechanical polishing (CMP) and electrochemical mechanical polishing (ECMP). These techniques, when used to remove conductive material, such as copper, often may result in topographical defects, such as dishing, erosion, and corrosion that may affect subsequent processing of the substrate. Dishing occurs when a portion of the surface of the inlaid metal of the interconnection formed in the interlayer dielectric is excessively polished, resulting in one or more concave depressions, which may be referred to as concavities or recesses. Erosion, characterized by excessive polishing of the layer not targeted for removal, such as a dielectric layer surrounding a metal feature, may also occur. Corrosion occurs when an exposed conductive material, such as copper, oxidizes. The presence of these topographical defects will result in final products that are unacceptable.

CMP and ECMP are often performed in an integrated tool with multiple platens. For example, three platens may be arranged in an integrated tool. Rotational carrier heads are used to transfer a substrate between the platens. The substrate may be initially exposed to an ECMP process with a first composition in the first platen, then exposed to two CMP processes with a second and third composition in two additional platens. Generally, the different compositions may be electrolytes and may contain different reactive agents, optional abrasive particles, or chemically-reactive catalyzers.

One way to prevent dishing, erosion, and corrosion is to avoid cross-contamination of compositions as a substrate moves between platens with different compositions. For example, as a substrate travels from the first to the second platen, the substrate may have residue of the first platen on the substrate surface or in the carrier head. Often, the chemical components of the first composition are not compatible with the second composition and cross-contamination may occur. Incompatibility can be characterized as a large difference in chemical, electrical, or abrasive properties that can be manifested by changes in composition properties including polarization voltage or by precipitation of abrasives, dissolved metals, or other composition components. The second composition, upon exposure to components in the first composition, has different electrochemical properties and experiences abrasive precipitation. These changes in the composition electrochemical and abrasive properties increase the likelihood of dishing, erosion, and corrosion.

Rinse solutions of simple deionized water or BTA based solutions used in the past do not remove the contamination efficiently and result in processes with cross-contamination defects. Therefore, it is desirable to provide a rinse solution to minimize the effects of cross-contamination including the differences in composition electrochemical properties and abrasive precipitation.

### SUMMARY OF THE INVENTION

The present invention generally provides a composition and method for rinsing a substrate including deionized water, one or more carboxylate acid containing compounds, one or more surfactants, and one or more corrosion inhibitors. The present invention also provides a method for rinsing a substrate between exposure to platens including moving the substrate from a first platen to a second platen, exposing the substrate to a rinse solution comprising one or more carboxylate acid containing compounds, one or more surfactants, and one or more corrosion inhibitors, and moving the substrate to a second platen.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a plan view of an electrochemical mechanical planarizing system.

FIG. 2 is a schematic side view of a portion of a carrier head including a fluid rinsing system for cleaning a cavity formed in the carrier head.

### DETAILED DESCRIPTION

The present invention relates to a rinse step performed by or on a carrier head in a CMP or ECMP process as the carrier head rests on one of the platens or as the carrier head moves between platens in the system.

For ease of description and understanding, the following description will refer to substrates, which include but are not limited to semiconductor wafers, semiconductor workpieces and other workpieces such as optical planks, memory disks and the like.

Apparatus

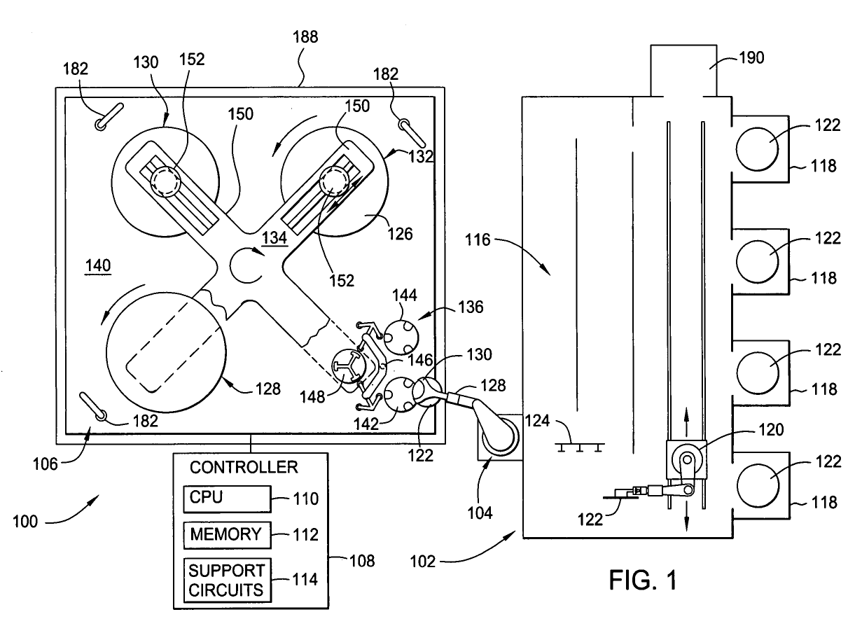

FIG. 1 is a plan view of one embodiment of a planarization system 100 having an apparatus for electrochemically processing a substrate. The system 100 generally comprises a factory interface 102, a loading robot 104, and a planarizing module 106. The loading robot 104 is disposed to facilitate the transfer of substrates 122 between the factory interface 102 and the planarizing module 106.

A controller 108 is provided to facilitate control and integration of the modules of the system 100. The controller 108 comprises a central processing unit (CPU) 110, a memory 112, and support circuits 114. The controller 108 is coupled to the various components of the system 100 to facilitate control of the planarizing, cleaning, and transfer processes.

The factory interface 102 generally includes a metrology module 190, a cleaning module 116 and one or more substrate cassettes 118. An interface robot 120 is employed to transfer substrates 122 between the substrate cassettes 118, the cleaning module 116, and an input module 124. The input module 124 is positioned to facilitate transfer of substrates 122 between the planarizing module 106 and the factory interface 102 by grippers, for example, vacuum grippers or mechanical clamps.

The metrology module 190 is a non-destructive measuring device suitable for providing a metric indicative of the thickness profile of a substrate. The metrology module 190 may include eddy sensors, an interferometer, a capacitance sensor and other suitable devices. Examples of suitable metrology modules include ISCAN™ and IMAP™ substrate metrology modules, available from Applied Materials, Inc. The metrology module 190 provides the metric to the controller 108 wherein a target removal profile is determined for the specific thickness profile measured from the substrate.

The planarizing module 106 includes at least a first electrochemical mechanical planarizing (ECMP) station 132, disposed in an environmentally controlled enclosure 188. Examples of planarizing modules 106 that can be adapted to benefit from the invention include MIRRA™, MIRRA MESA™, REFLEXION™, REFLEXION LK™, and REFLEXION LK ECMP™ chemical mechanical planarizing systems, available from Applied Materials, Inc. of Santa Clara, Calif. Other planarizing modules, including those that use processing pads, planarizing webs, or a combination thereof, and those that move a substrate relative to a planarizing surface in a rotational, linear, or other planar motion may also be adapted to benefit from the invention.

In the embodiment depicted in FIG. 1, the planarizing module 106 includes the first ECMP station 132, a CMP station 130 and a second CMP station 128. Bulk removal of conductive material disposed on the substrate 122 may be performed through an electrochemical dissolution process at the first ECMP station 132. After the bulk material removal at the first ECMP station 132, the remaining conductive material is removed from the substrate at the CMP stations 130 and 132 through a two-step electrochemical mechanical process, wherein part of the multi-step process is configured to remove residual conductive material. The ECMP station 132 is used to perform both the bulk and multi-step conductive material removal on a single station. Alternatively, more than one ECMP station may be utilized to perform the multi-step removal process after the bulk removal process performed at a different station. It is also contemplated that the stations 128, 130, and 132 may be configured to electrochemically process the conductive material layer.

The exemplary planarizing module 106 also includes a transfer station 136 and a carousel 134 that are disposed on an upper or first side of a machine base 140. In one embodiment, the transfer station 136 includes an input buffer station 142, an output buffer station 144, a transfer robot 146, and a load cup assembly 148. The input buffer station 142 receives substrates from the factory interface 102 by means of the loading robot 104. The loading robot 104 is also utilized to return polished substrates from the output buffer station 144 to the factory interface 102. The transfer robot 146 is utilized to move substrates between the buffer stations 142, 144 and the load cup assembly 148.

In one embodiment, the transfer robot 146 includes two gripper assemblies, each having pneumatic gripper fingers that hold the substrate by the substrate's edge. The transfer robot 146 may simultaneously transfer a substrate to be processed from the input buffer station 142 to the load cup assembly 148 while transferring a processed substrate from the load cup assembly 148 to the output buffer station 144.

The carousel 134 is centrally disposed over the base 140. The carousel 134 typically includes a plurality of arms 150, each supporting a carrier head assembly 152. Two of the arms 150 depicted in FIG. 1 are shown in phantom such that the transfer station 136 and a planarizing surface 126 of the ECMP station 132 may be seen. The carousel 134 is indexable such that the carrier head assemblies 152 may be moved between the planarizing stations 128, 130, and 132 and the transfer station 136. A conditioning device 182 is disposed on the base 140 adjacent each of the planarizing stations 128, 130, and 132. The conditioning device 182 periodically conditions the planarizing material disposed in the stations 128, 130, and 132 to maintain uniform planarizing results.

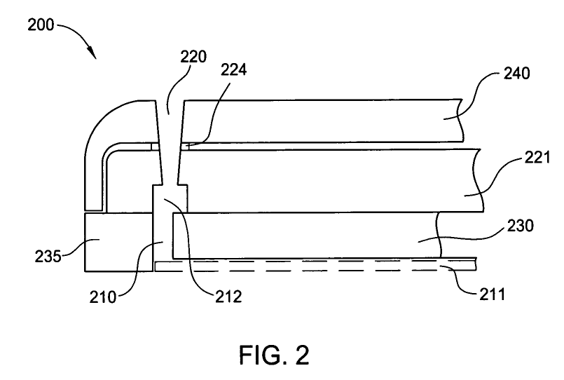

FIG. 2 is a sectional view of a carrier head 200 for carrying the substrate 211. The carrier head 200 includes a cover 240, a carrier 221, and a substrate backing assembly or membrane unit 230. The cover 240, the carrier 221, and the membrane unit 230 generally may be disc-shaped units adapted to hold a circular substrate 211.

The carrier head 200 further includes a retaining ring 235 that surrounds the membrane and the substrate. Generally, there is a small space 210 between the membrane unit 230 and retaining ring 235. Further, space 212 may be present at least behind a part of the membrane unit 230. These cavity-forming spaces or gaps may be required to allow vertical movement of the substrate 211. Vertical movement of the substrate with respect to the membrane unit 230 is a way to adjust the polishing pressure.

The spaces 210 and 212 form a fluid passage 220 to deliver rinsing fluid from the top of the carrier head 200. The cavity formed by the spaces 210 and 212 is defined around the entire perimeter of the carrier head. Thus, a plurality of fluid passages 220 may be provided along the perimeter of the carrier head. The fluid passages may have inlets along the upper surface of the carrier head or along the vertical exterior surface of the carrier or be at an angle between horizontal or vertical along the perimeter of the carrier head. Fluid is delivered through the passages to the interior of the carrier head from above or from the side of the carrier head 200 by a spray arm. Alternatively, an external nozzle may be provided to the passage 220, pressurizing the rinsing system. A pressure of up to 1000 psi may be provided by the nozzles. Typically, a pressure of about 30 psi may be used.

Chemical components from the first composition remaining on the substrate or along the surfaces of the carrier head can be flushed from the substrate surface and carrier head surfaces as fluid flows through the fluid passage by the force of gravity.

A typical flow through the entire cavity of the carrier head may be for between about 1 L/min and about 10 L/min. A flow rate between about 1 L/min and about 4 L/min is preferred.

Some embodiments of ECMP processes may provide fluid through the base of the pad. Additional information about the apparatus for ECMP and CMP equipment may be obtained in U.S. patent application Ser. No. APPM 010444 which is incorporated by reference herein. Detailed carrier head information and detailed carrier head rinse information may be obtained in U.S. patent application Ser. No. APPM 010699L02, which is incorporated by reference herein.

After polishing on the first platen, the substrate is moved by the carousel to the second platen. A rinsing step is performed in the head over the second platen. The cavities inside the carrier head, especially the gap between the membrane and the retaining ring, are rinsed by flowing a fluid or gas through the fluid passages in the head and the fluid drains to second platen.

As the substrate is moved from platen to platen, rinsing is needed. Also, repeating rinsing at the various locations between the polishing steps may be conducted. After the rinsing the pad and carrier head over the second platen, the substrate is polished on the second platen. The cleaning of the carrier head to avoid cross-contamination may be conducted while the carrier head when the substrate is positioned above the second platen. Alternatively, rinsing may be conducted while the carrier head with the substrate positioned therein is transferred from the first polishing station to the second polishing station. Also, the head rinse may be conducted in parallel to the pad cleaning. Thus, any cross contamination by rinsing over the platen of the second polishing station is, in theory, removed from the platen of the second polishing station. However, the rinse step may not adequately remove all of the first composition.

Typically, after the polishing step performed at the second platen, the pad and the substrate are rinsed over the third platen. Optionally, a head rinse according to any of the embodiments described above may be conducted over the second platen before the substrate is moved to the third platen.

According to an alternative embodiment, the substrate may first be moved to the third polishing station and a pad clean (pad rinse), a substrate rinse, and/or a head rinse is conducted over the third platen. Typically, at least a substrate and a pad rinse are conducted over the third platen. However, a head rinse according to any of the embodiments described herein can be added if cross-contamination needs to be reduced between the composition of the second platen and third platen. After the polishing step on the third platen, a post polishing rinse in the form of a head rinse according to any of the above described embodiments may be conducted on the third platen. Additionally or alternatively to the post rinse, a rinsing in the carrier head before transfer of the substrate to the factory interface can be conducted.

Methods and compositions for polishing a substrate to remove residues and minimize dishing within features and additional information about the chemical components of the compositions used in ECP and ECMP may be obtained in U.S. patent application Ser. No. 11/312,823, filed Dec. 19, 2005, which is incorporated by reference herein.

Rinse Solution

A cleaning or rinsing agent may be applied to the substrate after each polishing step to remove particulate matter and spent reagents from the polishing process, as well as to help minimize metal residue deposition on the polishing articles and defects formed on a substrate surface. The time for exposure to the rinse agent is between about 1 to about 20 seconds, preferably between about 10 to about 15 seconds.

A rinse agent is selected to rinse the substrate and also act as a composition stabilizer and a corrosion suppressor in the event the first platen composition or other material is not effectively removed before the substrate is exposed to the second platen composition. The rinse agent should be delivered at a rate of about 10 to about 1000 mL/min., preferably about 250 to about 350 mL/min. As the rinse agent is delivered through a composition delivery arm, additional deionized water may be delivered at a flow rate of about 5 L/min to about 10 L/min. Preferably, the additional deionized water is delivered at a flow rate of about 8 L/min. Thus, all concentrations below are approximate and will be different if deionized water is added through another line to the composition delivery arm.

The components of the rinse agent are selected to rinse, but also to help minimize the effects of composition contamination. Anionic organic reagents are the preferred class of compounds for the rinse agent. The rinse agent should include a combination of one or more carboxylate acid containing compounds, one or more surfactants, and one or more inhibitors. Alternatively, the rinse agent may contain only one individual component selected from the one or more carboxylate acid containing compounds, surfactants, and inhibitors. The balance of the rinse agent is deionized water.

The carboxylate acid containing compounds may include citric acid, succinic acid, tartaric acid, oxalic acid, acetic acid, glycolic acid, glycine, polyacrylic acid, ethylene diamine tetra acetic acid (EDTA), salts thereof, complexes thereof, derivatives thereof, and combinations thereof. Polyacrylic acid is a preferred carboxylate acid containing compound. The molecular weight of polyacrylic acid can be about 1,000 to 500,000 g/mol. The carboxylate acid containing compounds may include their salts with lithium, calcium, potassium, ammonium, or tetramethyl amonium. The concentration of the carboxylate acid containing compounds is between about 10 to about 1000 ppm.

The surfactants may include polystep-B1, ammonium dodecyl sulfate, sodium dodecyl sulfate, and dodecyltrimethylammonium bromide (DTAB). Ammonium dodecyl sulfate is a preferred surfactant. The concentration of the surfactant may be between about 0.01 to about 0.50 percent by volume of the rinse agent.

Suitable corrosion inhibitors include compounds having a nitrogen atom (N), such as organic compounds having an azole group. Examples of suitable compounds include benzotriazole (BTA), mercaptobenzotriazole, 5-methyl-1-benzotriazole (TTA), derivatives thereof, and combinations thereof. Other suitable corrosion inhibitors include film forming agents such as, imidazole, benzimidazole, triazole, and combinations thereof. Derivatives of benzotriazole, imidazole, benzimidazole, triazole, with hydroxy, amino, imino, carboxy, mercapto, nitro and alkyl substituted groups may also be used as corrosion inhibitors. The preferred inhibitors include BTA and derivatives thereof. The concentration of the corrosion inhibitor in the rinse agent is between about 10 to about 1000 ppm.

An example of a rinse agent that provides effective rinsing contains between about 200 to about 400 ppm polyacrylic acid, about 100 ppm ammonium dodecyl sulfate, and about 200 to about 400 ppm BTA.

It has been observed that substrates rinsed using the processes described herein have exhibited reduced topographical defects including dishing, erosion, and corrosion. Specifically, the ability of the second platen solution to transfer current over a range of potentials was measured to indicate the presence of contamination from the first platen solution. The electrical properties help predict the likelihood of the agent to increase uncontrolled polishing and thus encourage dishing and erosion across the surface of the substrate, agglomeration of the composition abrasive, and the oxidation of the exposed copper on substrate. When the log current is plotted as a function of potential for substrates exposed to no contamination and varied concentration of contamination from the first platen, the curves illustrate increasingly poor electrical properties as the concentration of contamination increases. Visual observation of the highest concentration composition solution indicates the solution is undesirable, especially because the composition abrasive agglomerates and condenses out of solution.

In contrast, when the log current is plotted as a function of potential for substrates exposed to no contamination or fixed concentration of contamination from the first platen and varied concentration of 10 ppm, 100 ppm, and 1000 ppm polyacrylic acid rinse agent, the curves illustrate the same discrepancy in performance between the substrate exposed to the composition that is not contaminated and the substrate that is contaminated with composition from the first platen. However, the curve for the substrates exposed to the second platen solution containing 10 ppm polyacrylic acid rinse agent with the contamination present was comparable to the curve for the substrate exposed to the second platen solution with no contamination. The curves for the 100 ppm and the 1000 ppm polyacrylic acid rinse agent were not as desirable. Also, visual observation of the composition when 10 ppm polyacrylic acid rinse agent was used indicates that the composition abrasives did not agglomerate and remained in solution when the second platen solution is contaminated with the first platen solution.

These results indicate that a rinse agent with a low concentration of components is desirable for decreasing the negative effects of the presence of contamination from the first platen when polishing at the second platen. These results also indicate that a high concentration of components yields a solution with electrical properties that are as undesirable as a solution without the rinse agent components.

Defect map testing was used to compare a substrate polished at the second platen after rinsing with no rinse solution components to a substrate polished at the second platen after rinsing with a rinse agent containing polyacrylic acid. Signifigantly fewer defects were observed in the results obtained with the polyacrylic acid rinse agent.

While the foregoing is directed to embodiments of the present invention, other and further embodiments of the invention may be devised without departing from the basic scope thereof, and the scope thereof is determined by the claims that follow.

1-12. (canceled)

13. A method for rinsing a substrate between exposure to platens, comprising:
moving the substrate from a first platen to a second platen; and
exposing the substrate to a rinse agent comprising:
one or more carboxylate acid containing compounds;
one or more surfactants with a concentration between about 0.01 to about 0.50 percent by volume; and
one or more corrosion inhibitors.

14. The method of claim 13, wherein the exposing the substrate to a rinse agent occurs for between about 1 to about 20 seconds.

15. The method of claim 14, wherein the exposing the substrate to a rinse agent occurs for between about 10 to about 15 seconds.

16. The method of claim 13, wherein the rinse agent is delivered at a rate of between about 10 to about 1000 mL/min.

17. The method of claim 16, wherein the rinse agent is delivered at a rate of between about 250 to 350 mL/min.

18. The method of claim 13, further comprising delivering about 5 to about 10 L/min deionized water at the same time as exposing the substrate to the rinse agent.

19. The method of claim 13, wherein the one or more carboxylate acid containing compounds are selected from the group consisting of citric acid, succinic acid, tartaric acid, oxalic acid, acetic acid, glycolic acid, glycine, and polyacrylic acid.

20. The method of claim 13, wherein the one or more surfactants are selected from the group consisting of polystep-B1, ammonium dodecyl sulfate, sodium dodecyl sulfate, and dodecyltrimethylammonium bromide.

21. The method of claim 13, wherein a concentration of the one or more carboxylate acid containing compounds is about 10 to about 1000 ppm.

22. The method of claim 13, wherein a concentration of the one or more corrosion inhibitors is about 10 to about 1000 ppm.

23. A method for rinsing a substrate between exposure to platens, comprising:
electrochemically mechanically polishing the substrate on a first platen;
moving the substrate from the first platen to a second platen; and
exposing the substrate to a rinse agent comprising:
one or more carboxylate acid containing compounds;
one or more surfactants; and
one or more corrosion inhibitors.

24. The method of claim 23, wherein the one or more carboxylate acid compounds is polyacrylic acid.

25. The method of claim 24, wherein a concentration of polyacrylic acid is between about 10 ppm to about 1000 ppm.

26. The method of claim 25, wherein the concentration of polyacrylic acid is 10 ppm.

27. The method of claim 23, wherein a concentration of the one or more carboxylate acid containing compounds; one or more surfactants; and one or more corrosion inhibitors is about 30 to about 1,000 ppm.

28. The method of claim 23, wherein the one or more corrosion inhibitors is benzotriazole.

29. The method of claim 23, wherein a concentration of the one or more corrosion inhibitors is about 10 to about 1000 ppm.

30. The method of claim 23, further comprising chemically mechanically polishing the substrate on the second platen.

31. The method of claim 23, wherein the one or more surfactants is ammonium dodecyl sulfate.

32. The method of claim 23, wherein the concentration of the one or more surfactants is about 0.01 to about 0.50 percent volume.
